(19) United States
(12) Patent Application Publication
(10) Pub. No.: US 2011/0261559 A1
(43) Pub. Date: Oct. 27, 2011

(54) Flashlight with Tail Cap and Remote Switch

(76) Inventors: Eric D. Couture, Manchester, NH (US); James Harvey, Windham, NH (US)

(21) Appl. No.: 13/092,205

(22) Filed: Apr. 22, 2011

Related U.S. Application Data
(60) Provisional application No. 61/326,900, filed on Apr. 22, 2010.

(51) Int. Cl. F21L 4/02; H01H 13/50; F21L 4/00

(52) U.S. Cl. 362/184; 362/208; 362/157; 200/1 R

(57) ABSTRACT

A flashlight has a remote switch receptacle centrally located in a push button in a tail cap assembly that allows a user to control the flashlight by pressing the push button or a remote plug inserted in the receptacle or by actuating the remote switch.

### CROSS REFERENCE TO RELATED APPLICATIONS

The present application claims the benefit of Provisional Patent Application Ser. No. 61/326,900, filed Apr. 22, 2011, the entire disclosure of which is incorporated herein by reference in its entirety.

### BACKGROUND OF THE INVENTION

Handheld, head mounted and weapon mount flashlights have been used for many years to help users better see under low light conditions. These flashlights typically have an incandescent lamp, a light emitting diode (LED), or other light source to provide general illumination of an area or person of interest. The output is typically a white light capable of projecting 40 to 150 lumens, although higher output lights are also known. Flashlights may project light in the visible spectrum in a multitude of colors and/or project light in the infrared spectrum. Flashlights typically have one or more actuators to turn the light ON or OFF.

Flashlights mountable on weapons may be referred to as tactical illuminators and may have an aiming laser for providing point of impact indication. These tactical illuminators may be attached to a weapon, for example a handgun, long gun, or shotgun, in a variety of different ways. Some tactical illuminators are secured to a handgun having a set of rails located under the barrel, in an area forward of the trigger guard, and some tactical illuminators are secured to the trigger guard. Tactical illuminators are often attached to long guns using a mechanism that cooperates with a rail on the weapon, for example a rail having a MIL-STD-1913 profile. The rails may be located above, below or to the sides of the barrel of the weapon and allow the operator the flexibility to secure the tactical illuminator in a variety of positions. Wired or wireless remotes may be secured to the weapon closer to the user's hand when in a ready position and may communicate with the device to turn the light and or laser ON and OFF to preselected light level.

### BRIEF DESCRIPTION OF THE DRAWINGS

Features and advantages of the present invention are set forth by description of embodiments consistent therewith, which description should be considered along with the accompanying drawings, wherein:

FIG. 1A is a perspective view of a flashlight and a remote switch assembly consistent with one embodiment of the invention.

FIG. 1B is a first view of a tail cap of the flashlight of FIG. 1A showing an opening for insertion of a remote plug of the remote switch assembly of FIG. 1A.

FIG. 1C is a second view of the tail cap of the flashlight of FIG. 1A with an alternative plug inserted in the opening for the remote plug.

FIG. 2A is a section view of a tail cap assembly consistent with one embodiment of the invention.

FIG. 2B is an exploded view of a push button assembly of the tail cap assembly of FIG. 2A.

FIG. 2C is an assembled view of the push button assembly of FIG. 2B.

FIG. 3 is a perspective view of the push button assembly of FIG. 2C spaced from the plug of FIG. 1B.

FIG. 4A is an electro-mechanical schematic of the flashlight of FIG. 1A.

FIG. 4B is an electro-mechanical schematic of the tail cap of the flashlight of FIG. 1A.

### DETAILED DESCRIPTION OF THE EMBODIMENTS

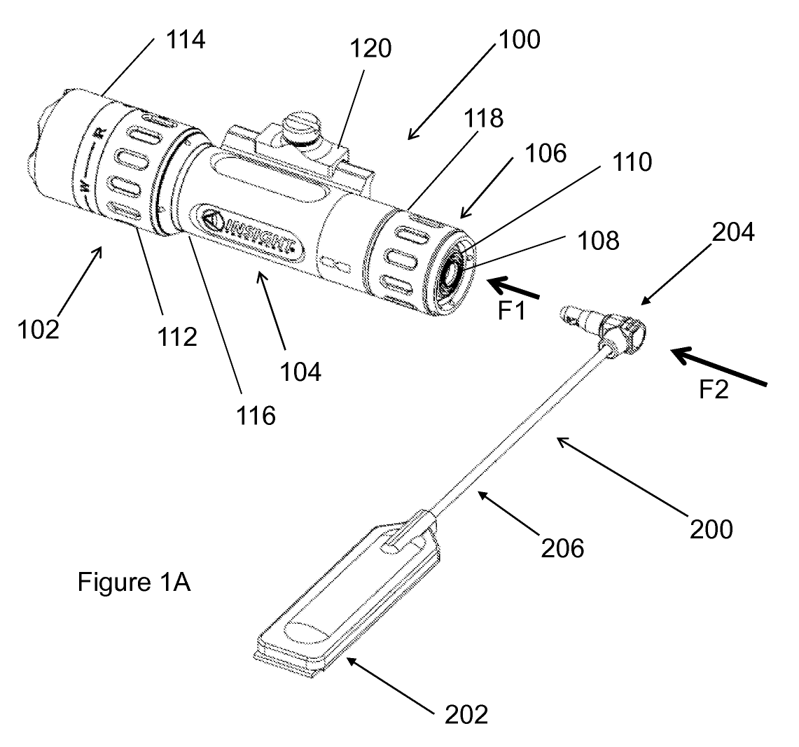

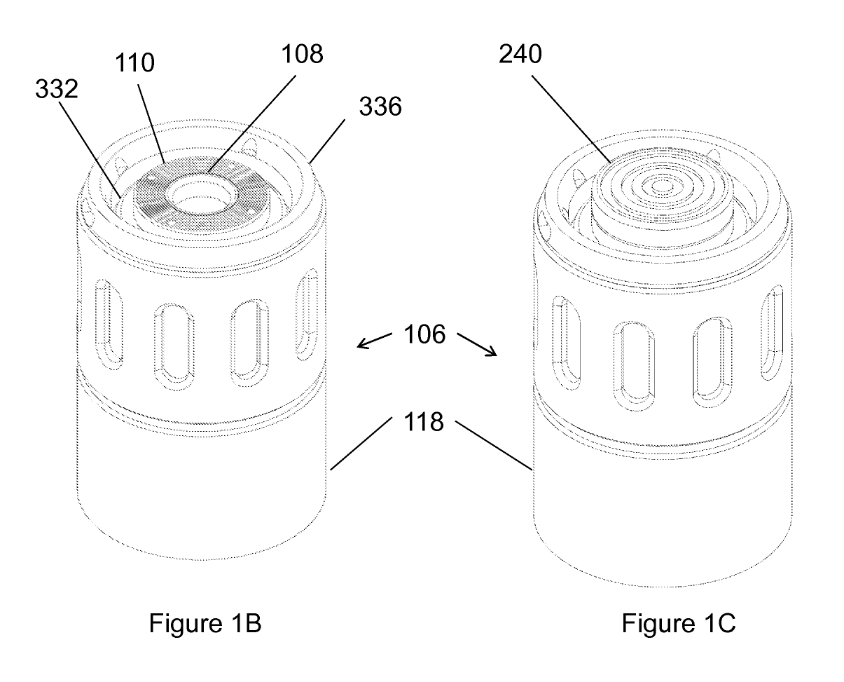

FIG. 1A is a perspective view of a flashlight 100 and a remote switch assembly 200 consistent with one embodiment of the invention, FIG. 1B is a first view of a tail cap assembly 106 of the flashlight 100 showing an opening 108 for insertion of a remote plug 204 of the remote switch assembly 200, and FIG. 1C is a second view of the tail cap assembly 106 of the flashlight 100 with an alternative plug 240 inserted in the opening 108.

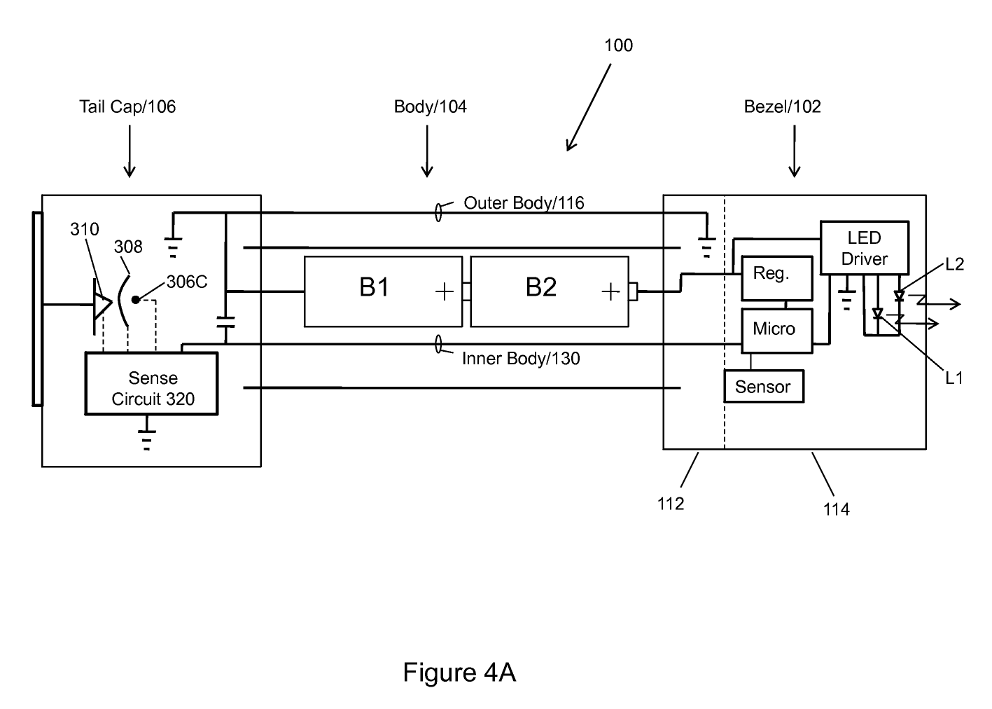

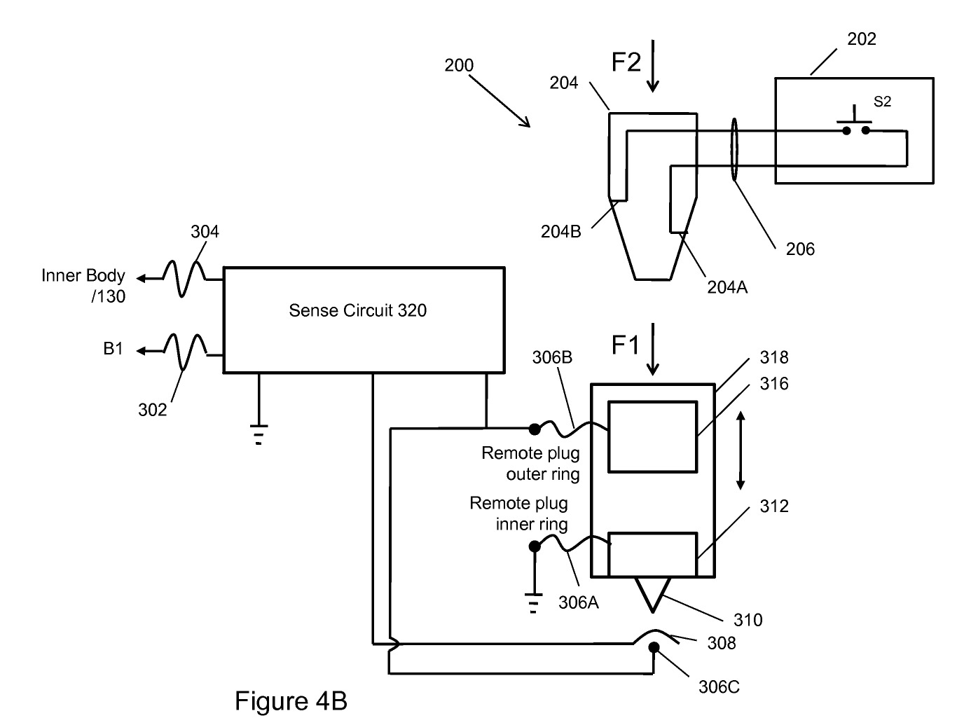

The flashlight 100 may have a bezel portion 102, a body portion 104, and the tail cap assembly 106. The bezel portion 102 may have one or more sources of illumination capable of casting visible or infrared light forward of the flashlight. The bezel portion 102 may have a reflector portion 114 and a selector portion 112. The bezel portion 102 may house the one or more sources of illumination L1, L2 (see FIG. 4A), for example an incandescent lamp, an LED, or laser, and suitable drive/regulator circuitry. One source of illumination, for example L1, may be a higher lumen output visible light source and the other source of illumination, for example L2, may be a lower lumen output visible or infrared light source. The wavelengths of the sources of illumination L1, L2, may be the same or different. The selector portion 112 may be rotatable relative to the body portion 104 to allow a user to select a source of illumination to be illuminated, a lumen output/brightness, a strobe feature, or a coded message. The selector 112 may have an OFF position that prevents accidental illumination, a second position in which the first source of illumination can be illuminated and a third position in which a second source of illumination can be illuminated.

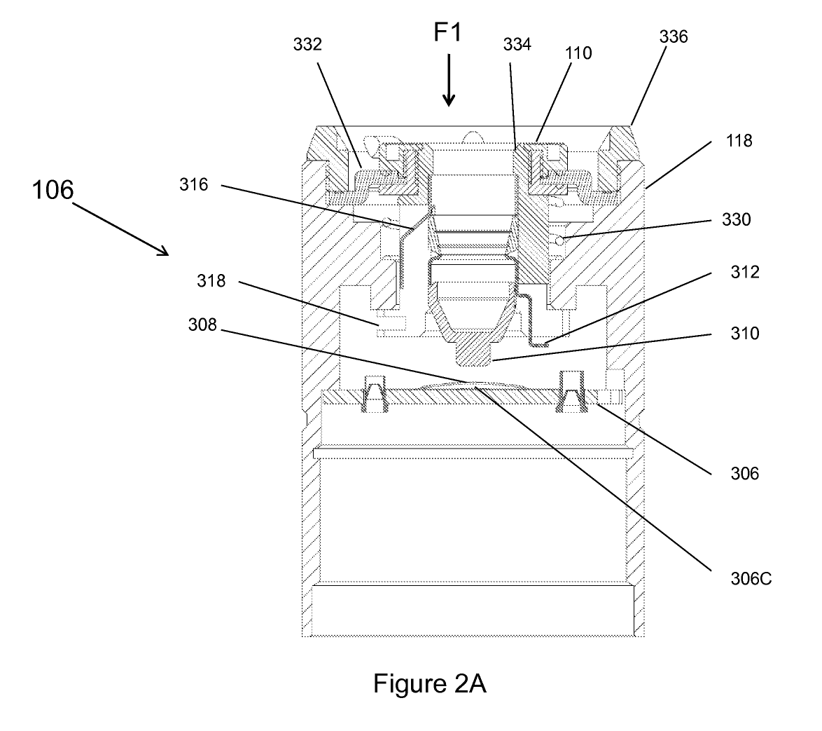

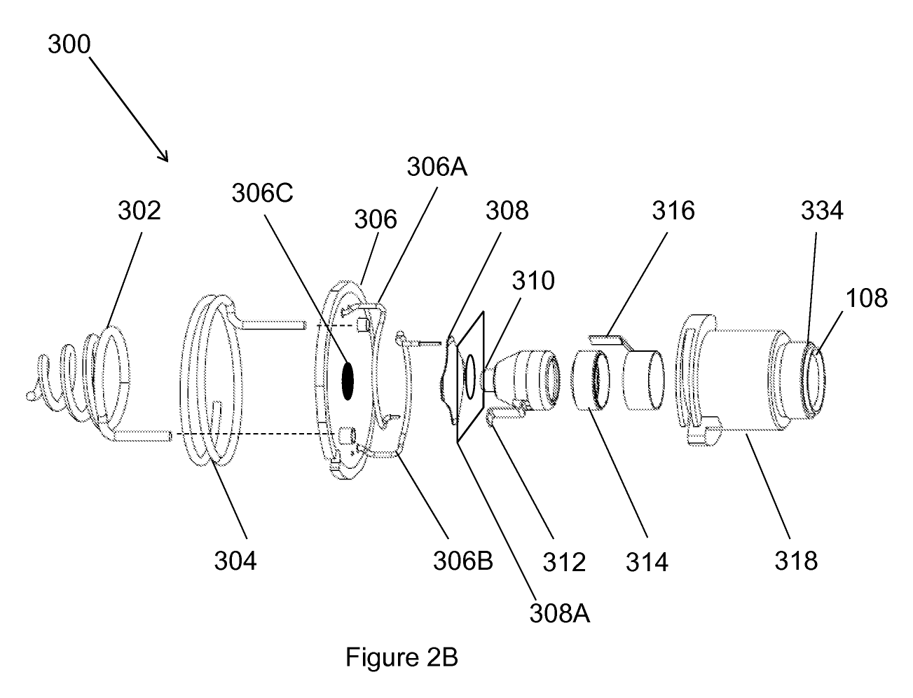

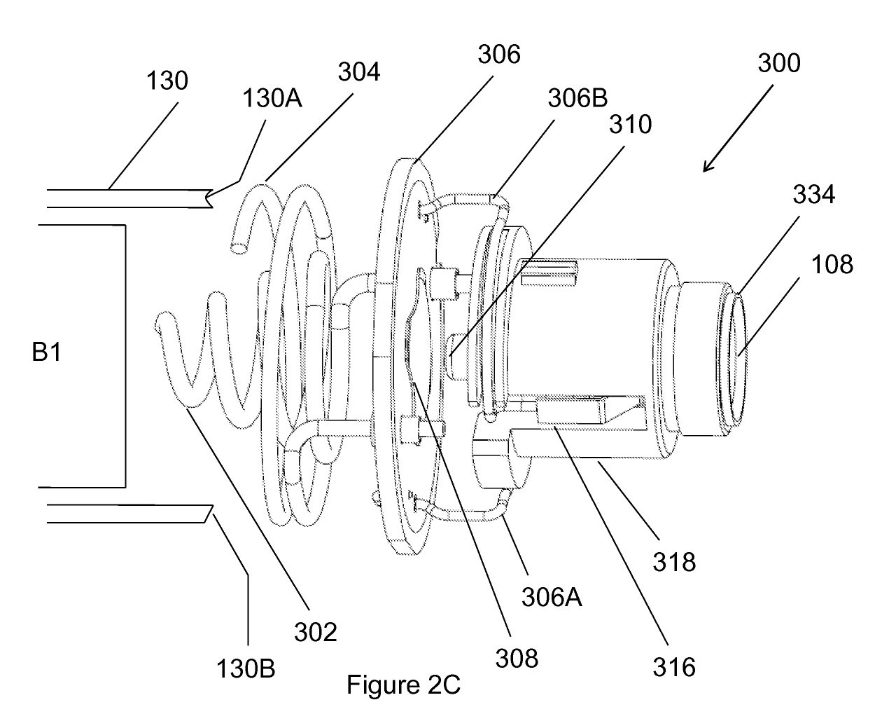

The body portion 104 may have an outer body 116 and an inner body 130 (see FIG. 2C or 4A) for housing one or more batteries B1, B2. The outer body 116 and the inner body 130 may provide structural integrity and be electrically conductive. An insulator between the outer body 116 and the inner body 130, for example a non-conductive plating or sleeve, may prevent the outer body 116 and the inner body 130 from shorting out. The flashlight 100 may be handheld or weapon mountable, for example with a suitable mounting mechanism 120.

The tail cap assembly 106 may have a tail cap member 118 that can be disconnected from the body portion 104 to allow access to a battery compartment. The tail cap assembly 106 may house a push button assembly 300 (see FIGS. 2B, 2C). A user may selectively control operation of the flashlight 100 through a push button 334 or the remote switch assembly 200. The opening 108 may be centrally located in the tail cap assembly 106. A user may depress the push button 334, for example in a direction generally parallel with a longitudinal axis of the flashlight, to control the operation of the flashlight 100, with or without the alternative plug 240 inserted in the opening 108.

FIG. 1B is a first view of the tail cap assembly 106 of the flashlight 100 showing the opening 108 for insertion of the plug 204 of the remote switch assembly 200 and FIG. 1C is a second view of the tail cap assembly 106 of the flashlight 100 showing the alternative plug 240 inserted in the opening 108. The remote switch assembly 200 may have an actuation portion 202, a cable portion 206, and the plug 204 that may be inserted in the opening 108 in the tail cap assembly 106. The user may selectively control operation of the flashlight 100 by closing a switch S2 (see FIG. 4B) in the remote switch assembly 200 or by pushing the plug 204, for example in a direction generally parallel with a longitudinal axis of the flashlight 100.

FIG. 2A is a section view of the tail cap assembly 106 consistent with one embodiment of the invention, FIG. 2B is an exploded view of a push button assembly 300 of the tail cap assembly 106, and FIG. 2C is an assembled view of the push button assembly 300. The push button assembly 300 may have a first spring 302, a second spring 304, a printed circuit board 306, a first wire 306A, a second wire 306B, a conductive dome 308, a first conductor 310, a second conductor 312, an insulator 314, a third conductor 316, and a housing 318. The push button 334 may be an integral portion of the housing 318. The conductive dome 308 may be secured to the printed circuit board 306, for example, with a piece of tape 308A with an opening centered over the dome. Alternatively, the conductive dome 308 may be soldered or adhered to the printed circuit board 306. The printed circuit board 306 may have traces along its periphery that come into contact with the tail cap member 118 to electrically connect the tail cap assembly 106 to electronics in the bezel portion 102. The first spring 302 may electrically connect traces on the printed circuit board 306 to the battery B1 and the second spring 304 may electrically connect traces on the printed circuit board 306 to the inner body 130. The end surface of the inner body 130 may not be generally perpendicular with the wall, for example the end surface 130A may be concave to help prevent the second spring 304 from coming out of contact with the inner body 130. Alternatively, the end surface 130B may be flat, but at an angle other than generally perpendicular, for example 10 to 80 degrees, with the walls of the inner body 130. Wire 306A may connect traces on the printed circuit board to second conductor 312 and wire 306B may connect traces on the printed circuit board to third conductor 316. First conductor 310 and second conductor 312 may be formed as one part or may be made separately and electrically coupled to each other. First conductor 310, second conductor 312, insulator 314, and third conductor 316 may be joined together and travel longitudinally with the housing 318 relative to the tail cap member 118. A first retainer 110 and a second retainer 336 may seal a flexible membrane 332 to the tail cap member 118 and the housing 318 to prevent water and debris from entering the push button assembly 300. A third spring 330 may bias the housing 318 away from the printed circuit board 306 and may provide tactile feedback to the user.

When a user exerts a force F1 on the push button 334, generally parallel to the longitudinal axis of the flashlight, the first conductor 310, second conductor 312, insulator 314, third conductor 316, and the housing 318 may move together and travel longitudinally within the tail cap member 118 until the first conductor 310 contacts the conductive dome 308 which may be sensed. When the first conductor 310 contacts the conductive dome 308, one or more electrical components in the sense circuit 320 may be shorted together or to common, which may be sensed by a controller, for example a micro in the bezel portion 102. The micro, through the sense circuit 320, may sense that the first conductor 310 is in contact with the conductive dome 308 using a variety of known sensing methods. If the user continues to press on the push button 334, first conductor 310 may cause conductive dome 308 to short out to a trace 306C on the printed circuit 306. When the conductive dome 308 is shorted out to trace 306C, one or more electrical components in the sense circuit 320 may be shorted together or to common, which may separately be sensed by the micro. The micro may be programmed to respond by causing the one or more sources of illumination L1, L2 to illuminate. For example, when the first conductor 310 contacts the conductive dome 308, the micro may cause the L1 to go to a first preset lumen output as long as the user applies a force and when the first conductor 310 causes the conductive dome 308 to short out to the printed circuit board, the micro may cause L1 to go to a second, and brighter, preset lumen output as long as the user applies a force. When the selector portion 112 is in a second position, the micro may cause L2 to go to a third preset lumen output as long as the user applies a force and when the first conductor 310 causes the conductive dome 308 to short out to the printed circuit board, the micro may cause L2 to go to a fourth, and brighter, preset lumen output as long as the user applies a force. Alternatively, the micro could be configured to turn L1 or L2 ON and stay ON until it receives another signal. Alternatively, the micro may cause one of the sources of illumination L1, L2 to fade UP or DOWN as long as a user applies a force. Other responses to applications of force are possible, for example, the one or more sources of illumination may strobe/dazzle or send out a message, for example SOS. The micro may control the state (brightness/lumen output, ON/OFF, blink rate, wavelength/color) of the plurality of sources of illumination based on inputs received from the sense circuit 320 and/or the selector portion 112, which may be rotatable about the longitudinal axis of the flashlight 100 or translatable. A sensor (see FIG. 4A) in the bezel portion 102 may communicate the rotational position of the selector portion 112 to the micro for processing.

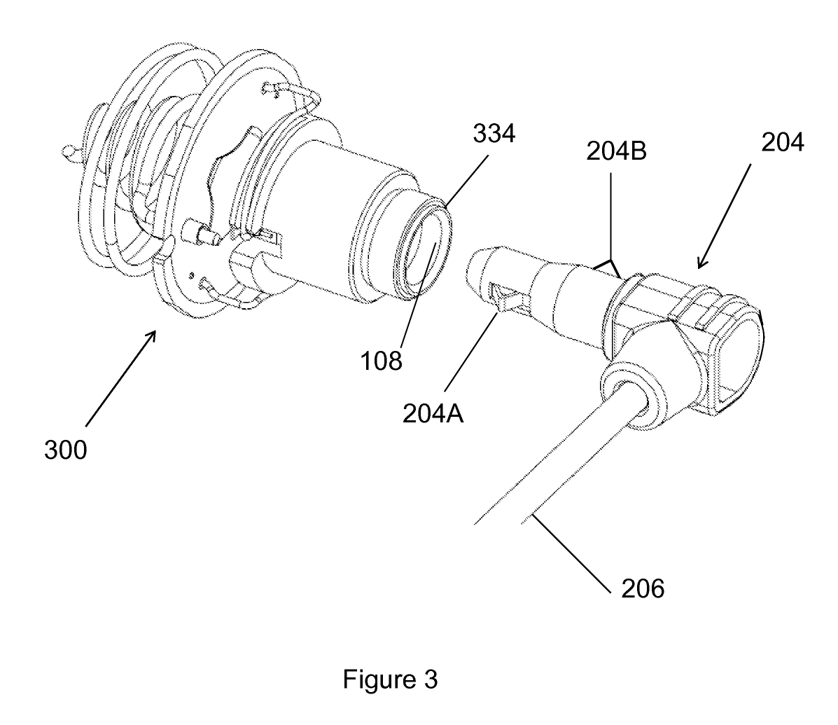

FIG. 3 is a perspective view of the push button assembly 300 spaced from the plug 204. The plug 204 may be inserted in the receptacle/opening 108 in the end of the tail cap assembly 106 and may have a first contact 204A that comes in contact with second conductor 312 and a second contact 204B that comes in contact with third conductor 316. When a user actuates the remote switch assembly 200 by compressing the actuation portion 202, the switch S2 in the actuation portion 202 may be closed, causing first contact 204A to be shorted to second contact 204B, which causes second conductor 312 to be shorted to third conductor 316, which may be sensed by the sense circuit 320. Even with the plug 204 inserted in the opening 108, the user may apply a force F2 generally parallel with the longitudinal axis of the flashlight 100 to the plug 204, causing housing 318 to move relative to the tail cap member 118 causing the first conductor 310 to contact dome switch 308 and then trace 306C which may be sensed by the sense circuit 320 resulting in the one or more sources of illumination to illuminate/change state.

FIG. 4A is an electro-mechanical schematic of the flashlight 100 and FIG. 4B is an electro-mechanical schematic of the tail cap assembly 106 and remote switch assembly 200. As shown, the inner body 130, the outer body 116 and the batteries B1, B2 may establish multiple electrical paths between the tail cap assembly 106 and the bezel assembly 102. Although shown having a generally circular cross section, other shapes for the flashlight body are possible.

Although several embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not limited thereby

What is claimed is:

1. A multi-position switch assembly, comprising:
a conductive element movable from a first position to a second position to a third position, in the first position the conductive element being spaced from a conductive dome, in the second position the conductive element being in contact with the conductive dome, and in the third position the conductive element shorting the conductive dome to a trace disposed under the dome.

2. The multi-position switch assembly of claim 1, wherein the conductive dome is secured to a printed circuit board with tape having an opening to allow the conductive element to come into electrical contact the conductive dome.

3. The multi-position switch assembly of claim 1, wherein the conductive element provides a first electrical path having a first resistance value when the conductive element is in the second position and the conductive element provides a second electrical path having a second resistance value when the conductive element is in the third position.

4. The multi-position switch assembly of claim 1, wherein the conductive element provides a first electrical path having a first resistor-capacitor combination when the conductive element is in the second position and the conductive element provides a second electrical path having a second resistor-capacitor combination when the conductive element is in the third position.

5. A tail cap of a flashlight, comprising:
a push button movable from a first position to a second position to cause a source of illumination coupled thereto to change its state, the push button having an opening in an end to accept a plug, the push button having a first contact and a second contact, the first contact aligning with a third contact in the plug when the plug is inserted in the opening and the second contact aligning with a fourth contact in the plug when the plug is inserted in the opening, the tail cap configured to change the state of the source of illumination when the third and fourth contacts are shorted together.

6. The tail cap of claim 5, wherein a switch disposed in an actuation portion of a remote switch assembly causes the third and fourth contacts in the plug to short together.

7. A flashlight, comprising:
a first source of illumination,
a battery, and
a push button configured to move from a first position, to a second position, to a third position, in the first position a conductive element is spaced from a conductive dome; in the second position the conductive element is in contact with the conductive dome causing the first source of illumination to illuminate at a first lumen output; and in the third position the conductive element shorting the conductive dome to a trace disposed under the dome causing the first source of illumination to illuminate at a second and different lumen output.

8. The flashlight of claim 7, wherein the push button has an opening to accept a plug; a first contact; and a second contact, the first contact aligning with a third contact in the plug when the plug is inserted in the opening and the second contact aligning with a fourth contact in the plug when the plug is inserted in the opening, the push button configured to change the state of the first source of illumination when the third and fourth contacts are shorted together.

9. The flashlight of claim 8, wherein the flashlight has a generally circular tail cap and the opening in the push button switch assembly is centrally located within the tail cap.

10. The flashlight of claim 7, wherein the flashlight has a second source of illumination and a selector for selecting which source of illumination will illuminate when the push button is actuated.

11. A flashlight, comprising:
a first source of illumination;
a battery; and
a movable push button movable from a first position in which the first source of illumination is not energized by the battery to a second position in which the first source of illumination is energized by the battery, the movable push button having an opening configured to accept a plug from a remote switch assembly, actuation of a switch in the remote switch assembly causing the first source of illumination to be energized by the battery.

12. The flashlight of claim 11, wherein the flashlight has a generally circular tail cap and the opening in the push button switch assembly is centrally located within the tail cap.

13. The flashlight of claim 11, wherein the flashlight has a second source of illumination and a selector for selecting which source of illumination will illuminate when the push button is actuated.
